(19) United States
(12) Patent Application Publication
(10) Pub. No.: US 2009/0118451 A1
(43) Pub. Date: May 7, 2009

(54) Polypropylene Random Copolymers Having High Melt Flow Rates for Injection Molding and Melt Blown Applications

(75) Inventors: Alexander Fuchs, Ferrara (IT); Ralf Nickles, Eschau (DE); Bernd Schuetz, Lampertheim (DE)

Correspondence Address: Basell USA Inc., Delaware Corporate Center II, 2 Righter Parkway, Suite #300, Wilmington, DE, 19803, US

(73) Assignee: BASELL POLYOLEFINE GMBH, Wesseling (DE)

(21) Appl. No.: 12/083,881

(22) PCT Filed: Oct. 12, 2006
(86) PCT No.: PCT/EP2006/067348

§ 371 Date: Apr. 21, 2008

Related U.S. Application Data
(60) Provisional application No. 60/729,478, filed on Oct. 21, 2005.

(51) Int. Cl. C08F 10/06

(52) U.S. Cl. 526/351

(57) ABSTRACT

Polypropylene resin comprising a propylene copolymer said polypropylene resins is endowed with the following features:
a) melt flow rate (MFR) (ISO 1133) (230° C./2.16 kg) comprised between 90 and 3000 g/10′;
b) distribution of molecular weight Mw/Mn lower than 4;
c) hexane extractables according FDA regulations of less than 2.6 wt. %,
d) xylene solubles of less than 2.2 wt. %;
e) isotactic pentads (mmmm) measured with by ¹³C-NMR higher than 90%; and
f) melting point of the powder measured by DSC is between 135° C. and 152° C.;
with the proviso that the propylene copolymer was not visbroken.

This application is the U.S. national phase of International Application PCT/EP2006/067348, filed Oct. 12, 2006, claiming the benefit under 35 U.S.C. 119(e) of U.S. Provisional Application No. 60/729,478, filed Oct. 21, 2005; the disclosures of International Application PCT/EP2006/067348 and U.S. Provisional Application No. 60/729,478, each as filed, are incorporated herein by reference.

The present invention relates to a polypropylene random copolymer endowed with some features especially suitable for injection molding application and for melt blown and compounding applications.

Polypropylene random copolymer has been used for several years for casting cups and molds. For example in WO 02/44260 a polypropylene having a melt flow rate lower than 100 g/10 min is described for injection molding in particular for the obtainment of contact lenses and other precision application.

However there is still a need for a polypropylene random copolymer-based resin having a balancement of improved properties. In particular when the polypropylene random copolymer-based resin is endowed with a high stiffness, well balanced impact at room temperature and at 0° C., narrow molecular weight distribution, high transparency and good flowability it is fit for the replacement of polystyrene in injection molding application such as the production of cups or other similar objects like plastic cutlery or food containers, where high transparency is required. Products with even higher flowability can be used for melt blown applications as well as for compounding applications.

Therefore an object of the present invention is a polypropylene resin comprising a propylene copolymer said polypropylene resins is endowed with the following features:
a) a propylene copolymer having a melt flow rate (MFR) (ISO 1133) (230° C./2.16 kg) comprised between 90 and 3000 g/10′, preferably between 120 and 3000 g/10′ and more preferably between 130 and 2500 g/10′ measured on the powder;
b) distribution of molecular weight Mw/Mn lower than 4; preferably lower than 3; more preferably lower than 2.5;
c) hexane extractables determined according FDA regulations of less than 2.6 wt. %, more preferred less than 2.0 wt. % even more preferred less than 1.7 wt. % and most preferred less than 1 wt. %
d) xylene solubles of less than 2.2 wt. %, more preferred less than 1.7 wt. %
e) isotactic pentads (mmmm) measured by ¹³C-NMR higher than 90%; preferably higher than 92%; more preferably higher than 95% and even more preferably higher than 96%.
f) a propylene copolymer having a melting point measured by DSC higher than 130° C., preferably between 135 and 153° C. more preferably between 139 and 153° C. and even more preferably between 145° C. and 153° C. measured on the powder;
   with the proviso that the propylene copolymer was not visbroken.

The process for visbreaking a polymer consists in increasing the MFR of the latter by lowering the molecular weight of the polymers by means of chemical reactions such as radical reaction initiated by peroxides. The polymers obtained in this way presents some drawback, such as an high yellowing index, for this reason the polypropylene resin object of the present invention does not contains residues of peroxidic compounds.

Preferably the polypropylene resin of the object of the present invention is further endowed with the following features:
g) haze measured according to ASTM D 1003 (1 mm placque) comprised between 5% and 25%; preferably between 7% and 20%; more preferably between 7% and 15%;
h) flexural modulus measured according ISO 178 comprised between 1100 N/m² and 2000 N/m²; preferably comprised between 1200 N/m² and 2000 Nm² and most preferably between 1350 N/m² and 2000 N/m².

Preferably the polypropylene resins having a MFR value between 90 and 500 g/10′ at 230° C. have at a shear rate of 100 1/s at 250° C. a viscosity between 100 Pas and 11 Pas, more preferred between 80 Pas and 11 Pas and most preferably between 50 Pas and 11 Pas

Preferably the polypropylene resins having a MFR value higher than 500 g/10′ at 230° C. of the present invention have at a shear rate of 1500 1/s at 250° C. a viscosity between 11 Pas and 1 Pas, more preferred between 10 Pas and 1 Pas and most preferably between 7 Pas and 1 Pas

The propylene copolymer of the present invention has preferably a content of 2.1-insertions lower than 0.5%, more preferred ≦0.3%. measured by ¹³C NMR spectroscopy. The content of 1.3 insertions is preferably below 0.2%, more preferred ≦0.1%.

The propylene copolymer of the polypropylene resin object of the present invention is a propylene copolymer containing up to 5% by mol of ethylene or alpha olefins of formula CH₂═CHA derived units, wherein A is a C₂-C₂₀ alkyl radical. Preferably the comonomers used in the propylene copolymers are ethylene or 1-butene. The amount of comonomer in the propylene copolymer ranges preferably from 0.1% to 4% by mol, more preferably from 0.1% by mol to 3% by mol.

The polypropylene resin of the present invention preferably further comprises customary amounts of customary additives known to those skilled in the art, e.g. stabilizers, lubricants and mold release agents, fillers, nucleating agents, antistatics, plasticizers, dyes, pigments, anti-fungal, anti-microbial agents, film cavitating agents or flame retardants. In general, these are incorporated during granulation of the pulverulent product obtained in the polymerization. Customary stabilizers include antioxidants such as sterically hindered phenols, sterically hindered amines or UV stabilizers, processing stabilizers such as phosphites or phosphonites, acid scavengers such as calcium stearate or zinc stearate or dihydrotalcite, as well as calcium, zinc and sodium caprylate salts. In general, the propylene copolymer compositions of the present invention contain one or more stabilizers in amounts of up to 2% by weight.

Suitable lubricants and mold release agents are, for example, fatty acids, calcium, sodium or zinc salts of fatty acids, fatty acid amides or low molecular weight polyolefin waxes, which are usually used in concentrations of up to 2% by weight.

Possible fillers are, for example, talc, calcium carbonate, chalk or glass fibers, and these are usually used in amounts of up to 50% by weight.

Examples of suitable nucleating agents are inorganic additives such as talc, silica or kaolin, salts of monocarboxylic or polycarboxylic acids, e.g. sodium benzoate or aluminum tert-butylbenzoate, dibenzylidenesorbitol or its C₁-C₈-alkyl-substituted derivatives such as methyldibenzylidenesorbitol, ethyldibenzylidenesorbitol or dimethyldibenzylidenesorbitol or salts of diesters of phosphoric acid, e.g. sodium 2,2′-methylenebis(4,6,-di-tert-butylphenyl)phosphate. The nucleating agent content of the propylene copolymer composition is generally up to 5% by weight.

Such additives are generally commercially available and are described, for example, in Gächter/Müller, Plastics Additives Handbook, 4th Edition, Hansa Publishers, Munich, 1993.

When the MFR of the polypropylene resin of the present invention is lower than 200 g/10′ it can contain from 0.03 to 1% by weight, preferably from 0.05 to 0.25% by weight, of a nucleating agent, in particular dibenzylidenesorbitol or a dibenzylidenesorbitol derivative, particularly preferably dimethyldibenzylidenesorbitol.

Furthermore the addition of glyceryl monostearate (tradenames for these products are Loxiol EP 55, Atmer 122, Baerolub MS 90 or Atmer 129) is preferred in the present invention. The range contains from 0.05% by weight to 0.6% by weight, more preferred from 0.1% to 0.4% by weight. The polypropylene resin object of the present invention is particularly suitable to be used for injection molding. For example the polypropylene resin of the present invention can be advantageously used for obtaining cups or other similar tools. In particular the value of IZOD at low temperature (0° C.), makes the resin of the present invention particularly suitable for injection molding applications

Thus a further object of the present invention is the use of the propylene resin described above for the production of molded articles.

A further object of the present invention are molded article obtained by using the propylene resin object of the present invention.

The random propylene copolymer of the propylene resin object of the present invention can be obtained by using a metallocene-based catalyst system.

In particular said propylene copolymer is obtainable by using a catalyst system obtainable by contacting:

a) a metallocene compound of formula (I)

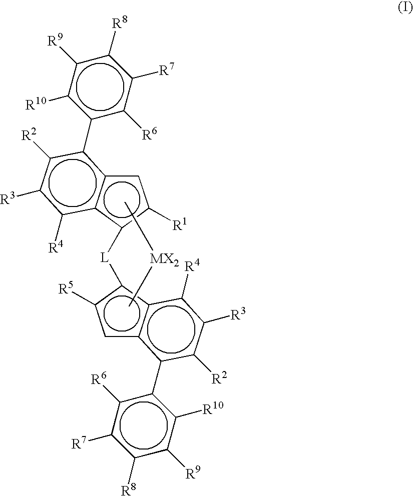

wherein
M is a transition metal belonging to group 3, 4, 5, 6 or to the lanthanide or actinide groups in the Periodic Table of the Elements; preferably M is titanium, zirconium or hafnium;
X, same or different, is a hydrogen atom, a halogen atom, or a R, OR, OSO₂CF₃, OCOR, SR, NR₂ or PR₂ group, wherein R is a are linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radicals; optionally containing heteroatoms belonging to groups 13-17 of the Periodic Table of the Elements; preferably R is a linear or branched C₁-C₂₀-alkyl radical; or two X can optionally form a substituted or unsubstituted butadienyl radical or a OR′O group wherein R′ is a divalent radical selected from C₁-C₄₀ alkylidene, C₆-C₄₀ arylidene, C₇-C₄₀ alkylarylidene and C₇-C₄₀ arylalkylidene radicals; preferably X is a hydrogen atom, a halogen atom or a R group; more preferably X is chlorine or a C₁-C₁₀-alkyl radical; such as methyl, or ethyl radicals;
L is a divalent C₁-C₄₀ hydrocarbon radical optionally containing heteroatoms belonging to groups 13-17 of the Periodic Table of the Elements or a divalent silylidene radical containing up to 5 silicon atom; preferably L is a divalent bridging group selected from C₁-C₄₀ alkylidene, C₃-C₄₀ cycloalkylidene, C₆-C₄₀ arylidene, C₇-C₄₀ alkylarylidene, or C₇-C₄₀ arylalkylidene radicals optionally containing heteroatoms belonging to groups 13-17 of the Periodic Table of the Elements, and silyliene radical containing up to 5 silicon atoms such as SiMe₂, SiPh₂; preferably L is a group (Z(R″)₂)ₙ wherein Z is a carbon or a silicon atom, n is 1 or 2 and R″ is a C₁-C₂₀ hydrocarbon radical optionally containing heteroatoms belonging to groups 13-17 of the Periodic Table of the Elements; preferably R″ is a linear or branched, cyclic or acyclic, C₁-C₂₀-alkyl, C₂-C₂₀ alkenyl, C₂-C₂₀ alkynyl, C₆-C₂₀-aryl, C₇-C₂₀-alkylaryl or C₇-C₂₀-arylalkyl radicals optionally containing heteroatoms belonging to groups 13-17 of the Periodic Table of the Elements; more preferably the group (Z(R″)₂)ₙ is Si(CH₃)₂, SiPh₂, SiPhMe, SiMe(SiMe₃), CH₂, (CH₂)₂, and C(CH₃)₂; even more preferably (Z(R″)₂)ₙ is Si(CH₃)₂.
R¹ and R⁵ are a C₁-C₄₀ hydrocarbon radical optionally containing heteroatoms belonging to groups 13-17 of the Periodic Table of the Elements; preferably R¹ and R⁵ are linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radicals; optionally containing heteroatoms belonging to groups 13-17 of the Periodic Table of the Elements; more preferably R¹ and R⁵ are a linear or branched, saturated or unsaturated C₁-C₂₀-alkyl radical;
R², R³ and R⁴, equal to or different from each other, are hydrogen atoms or C₁-C₄₀ hydrocarbon radicals optionally containing heteroatoms belonging to groups 13-17 of the Periodic Table of the Elements; preferably R², R³ and R⁴, equal to or different from each other are hydrogen atoms or linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; optionally containing heteroatoms belonging to groups 13-17 of the Periodic Table of the Elements; more preferably R², R³ and R⁴ are hydrogen atoms or C₁-C₂₀-alkyl radicals;
R⁶, R⁷, R⁸, R⁹, and R¹⁰ equal to or different from each other, are hydrogen atoms or C₁-C₄₀ hydrocarbon radicals optionally containing heteroatoms belonging to groups 13-17 of the Periodic Table of the Elements; preferably R², R³ and R⁴, equal to or different from each other are hydrogen atoms or linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; optionally containing heteroatoms belonging to groups 13-17 of the Periodic Table of the Elements; more preferably R², R³ and R⁴ are hydrogen atoms or C₁-C₄₀-alkyl radicals; with the proviso that at least one among R⁶, R⁷, R⁸, R⁹, and R¹⁰ is different from an hydrogen atom; preferably R⁶, R⁷, R⁹, and R¹⁰ R⁸ are hydrogen atoms;
preferably R⁸ is a C₁-C₄₀-alkyl radicals, more preferably R⁸ is a C₁-C₄₀-alkyl radical wherein the atom in the alpha position is a secondary carbon or a tertiary carbon, such as isopropyl or tertbutyl radicals;
   b) at least an alumoxane or a compound able to form an alkylmetallocene cation; and
   c) optionally an organo aluminum compound.

Preferably the substituent R¹ is a linear C₁-C₂₀-alkyl radical such as methyl or ethyl radicals and the substituent R⁵ is a branched C₁-C₂₀-alkyl radical, preferably the substituent R⁵ is a branched C₁-C₂₀-alkyl radical wherein the carbon atom in the alpha position is a secondary or a tertiary carbon atom, such as an isopropyl radical.

Alumoxanes used as component b) in the catalyst system according to the present invention can be obtained by reacting water with an organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number. In this reaction the molar ratio of Al/water is preferably comprised between 1:1 and 100:1.

The alumoxanes used in the process according to the invention are considered to be linear, branched or cyclic compounds containing at least one group of the type:

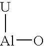

wherein the substituents U, same or different, are defined above.

In particular, alumoxanes of the formula:

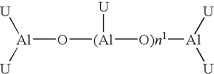

can be used in the case of linear compounds, wherein n¹ is 0 or an integer of from 1 to 40 and the substituents U are defined as above; or alumoxanes of the formula:

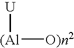

can be used in the case of cyclic compounds, wherein n² is an integer from 2 to 40 and the U substituents are defined as above.

Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO).

Particularly interesting cocatalysts are those described in WO 99/21899 and in WO01/21674 in which the alkyl and aryl groups have specific branched patterns.

Non-limiting examples of aluminium compounds that can be reacted with water to give suitable alumoxanes (b), described in WO 99/21899 and WO01/21674, are: tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-butyl)aluminium, tris(2,3-dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Among the above aluminium compounds, trimethylaluminium (TMA), triisobutylaluminium (TIBA), tris(2,4,4-trimethyl-pentyl)aluminium (TIOA), tris(2,3-dimethylbutyl)aluminium (TDMBA) and tris(2,3,3-trimethylbutyl)aluminium (TTMBA) are preferred.

Non-limiting examples of compounds able to form an alkylmetallocene cation are compounds of formula D⁺E⁻, wherein D⁺ is a Brønsted acid, able to donate a proton and to react irreversibly with a substituent X of the metallocene of formula (I) and E⁻ is a compatible anion, which is able to stabilize the active catalytic species originating from the reaction of the two compounds, and which is sufficiently labile to be removed by an olefinic monomer. Preferably, the anion E⁻ comprises one or more boron atoms. More preferably, the anion E⁻ is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentafluorophenyl borate is particularly preferred compound, as described in WO 91/02012. Moreover, compounds of formula BAr₃ can be conveniently used. Compounds of this type are described, for example, in the International patent application WO 92/00333. Other examples of compounds able to form an alkylmetallocene cation are compounds of formula BAr₃P wherein P is a substituted or unsubstituted pyrrol radical. These compounds are described in WO 01/62764. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are: Triethylammoniumtetra(phenyl)borate, Tributylammoniumtetra(phenyl)borate, Trimethylammoniumtetra(tolyl)borate, Tributylammoniumtetra(tolyl)borate, Tributylammoniumtetra(pentafluorophenyl)borate, Tributylammoniumtetra(pentafluorophenyl)aluminate, Tripropylammoniumtetra(dimethylphenyl)borate, Tributylammoniumtetra(trifluoromethylphenyl)borate, Tributylammoniumtetra(4-fluorophenyl)borate, N,N-Dimethylbenzylammonium-tetrakispentafluorophenylborate, N,N-Dimethylhexylamonium-tetrakispentafluorophenylborate, N,N-Dimethylaniliniumtetra(phenyl)borate, N,N-Diethylaniliniumtetra(phenyl)borate, N,N-Dimethylaniliniumtetrakis(pentafluorophenyl)borate, N,N-Dimethylaniliniumtetrakis(pentafluorophenyl)aluminate, N,N-Dimethylbenzylammonium-tetrakispentafluorophenylborate, N,N-Dimethylhexylamonium-tetrakispentafluorophenylborate, Di(propyl)ammoniumtetrakis(pentafluorophenyl)borate, Di(cyclohexyl)ammoniumtetrakis(pentafluorophenyl)borate, Triphenylphosphoniumtetrakis(phenyl)borate, Triethylphosphoniumtetrakis(phenyl)borate, Diphenylphosphoniumtetrakis(phenyl)borate, Tri(methylphenyl)phosphoniumtetrakis(phenyl)borate, Tri(dimethylphenyl)phosphoniumtetrakis(phenyl)borate, Triphenylcarbeniumtetrakis(pentafluorophenyl)borate, Triphenylcarbeniumtetrakis(pentafluorophenyl)aluminate, Triphenylcarbeniumtetrakis(phenyl)aluminate, Ferroceniumtetrakis(pentafluorophenyl)borate, Ferroceniumtetrakis(pentafluorophenyl)aluminate. Triphenylcarbeniumtetrakis(pentafluorophenyl)borate, and N,N-Dimethylaniliniumtetrakis(pentafluorophenyl)borate.

Additional examples of compounds of formula D⁺E⁻ that can be used according to the present invention are described in WO 04/005360, WO 02/102811 and WO 01/62764.

Organic aluminum compounds used as compound c) are those of formula HⱼAlU₃₋ⱼ or HⱼAl₂U₆₋ⱼ as described above.

The catalysts described above can also be supported on an inert carrier. This is achieved by depositing the metallocene compound a) or the product of the reaction thereof with the component b), or the component b) and then the metallocene compound a) on an inert support such as, for example, silica, alumina, Al—Si, Al—Mg mixed oxides, magnesium halides, styrene/divinylbenzene copolymers, polyethylene or polypropylene. The supportation process is carried out in an inert solvent such as hydrocarbon for example toluene, hexane, pentane or propane and at a temperature ranging from 0° C. to 100° C., preferably the process is carried out at room temperature.

A suitable class of supports which can be used is that constituted by porous organic supports functionalized with groups having active hydrogen atoms. Particularly suitable are those in which the organic support is a partially crosslinked styrene polymer. Supports of this type are described in European application EP-633 272.

Another class of inert supports particularly suitable for use according to the invention is that of polyolefin porous prepolymers, particularly polyethylene.

A further suitable class of inert supports for use according to the invention is that of porous magnesium halides such as those described in International application WO 95/32995.

The solid compound thus obtained, in combination with the further addition of the alkylaluminium compound either as such or prereacted with water if necessary, can be usefully employed in the gas-phase polymerization.

The following examples are given for illustrative purpose and do not intend to limit the invention.

### EXAMPLES

### Analysis

All data was obtained according to the following methods:

### ¹³C-NMR

NMR analysis. ¹³C-NMR spectra of PP were acquired on a DPX-400 spectrometer operating at 100.61 MHz in the Fourier transform mode at 120° C. The peak of the mmmm pentad carbon were used as internal reference at 21.8 ppm and 29.9 ppm respectively. The samples were dissolved in 1,1,2,2-tetrachloroethane-d2 at 120° C. with a 8% wt/v concentration in a 5 mm tube. Each spectrum was acquired with a 90° pulse, 12 seconds of delay between pulses and CPD (WALTZ 16) to remove 1H-13C coupling. About 2500 transients were stored in 32K data points using a spectral window of 6000 Hz.

The assignments of PP spectra were made according to “Selectivity in Propylene Polymerization with Metallocene Catalysts”, L. Resconi, L. Cavallo, A. Fait, F. Piemontesi, Chem. Rev., 100, 1253, (2000))

The mmmm content was obtained modelling the experimental pentad distribution with the enantiomorphic site model. The mmmm content of PP with high content of 2.1 (E) and 1.3 (H) errors was obtained as:

[mmmm]=100(Σ[CH₃]−5[mrrm]−5[E]−5[H])/(Σ[CH₃])

where Σ[CH₃] is the sum of all CH3 groups

The content of 2.1 and 3.1 errors was obtained as:

[E]=100(E₉/Σ[CH₂])

[H]=100(0.5H₂/Σ[CH₂])

where E₉ is the peak at 42.14 ppm, H₂ is the peak at 30.82 ppm and Σ[CH₂] is the sum of all CH₂ groups.

### Ethylene Content IR

Calibration is obtained by analyzing propylene/ethylene standard copolymers.

### Sample Preparation

By means of a hydraulic press, a sample film was molded between two aluminium foils at about 170° C. and a pressure of 10 kg/cm² for about a minute. The pressure is then realased and the sample was cooled at room temperature. The film thickness is determined according to the following table.

| Ethylene forecast (% wt) | Thickens mm |
|---|---|
| <2 | 0.5-1 |
| 2-5 | 0.3-0.5 |
| 5-10 | 0.1-0.3 |
| 10-25 | 0.1 |

The IR spectra is then recorded by using a FTIR apparatus. The ethylene content is then calculated according to the following formula

% ethylene(Wt)=A/(At.G)

wherein
G is the slope of the calibration straight line
A is the area of the band due to the methylenic sequences vs. a baseline plotted between the ends of the 790-660 cm⁻¹ range, after subtraction of the isotactic polypropylene reference spectrum from the sample spectrum in the same spectral range.

At is the area of the combination band of the sample spectrum between 4482 and 3950 cm⁻¹ vs. a baseline plotted between the ends of the range.

### Molecular Weights and MWD

Molecular weights and molecular weight distribution were measured at 145° C. using a Alliance GPCV 2000 instrument (Waters) equipped with three mixed-bed columns TosoHaas TSK GMHXL-HT having a particle size of 13 μm. The dimensions of the columns were 300×7.8 mm. The mobile phase used was vacuum distilled 1,2,4-Trichlorobenzene (TCB) and the flow rate was kept at 1.0 ml/min. The sample solution was prepared by heating the sample under stirring at 145° C. in TCB for two hours. The concentration was 1 mg/ml. To prevent degradation, 0.1 g/l of 2,6-diterbutyl-p-cresol were added. 326.5 μL of solution were injected into the column set. A calibration curve was obtained using 10 polystyrene standard samples (EasiCal kit by Polymer Laboratories) with molecular weights in the range from 580 to 7500000; additionally two other standards with peak molecular weight of 11600000 and 13200000 from the same manufacturer were included. It was assumed that the K values of the Mark-Houwink relationship were:

K=1.21×10⁻⁴ dL/g and α=0.706 for the polystyrene standards
K=1.90×10⁻⁴ dL/g and α=0.725 for the polypropylene samples
K=1.93×10⁻⁴ dL/g and α=0.725 for the random copolymer samples

A third order polynomial fit was used for interpolate the experimental data and obtain the calibration curve. Data acquisition and processing was done by using Empower 1.0 with GPCV option by Waters.

### Intrinsic Viscosity:

Intrinsic viscosity was measured in tetrahydronaphtalene (THN) solution obtained by dissolving the polymer at 135° C. for 1 hour.

### FDA Hexane Extractables

Code of Federal Regulations, Title 21, Volume 3, Revised as of Apr. 1, 2004, CITE: 21CFR177.1520

The hexane extractables of the rancomcopolymers were measured under the same conditions used for homopolymers (hexane under reflux)

### Xylene-Soluble Fraction

2.5 g of polymer and 250 mL of o-xylene are introduced in a glass flask equipped with a refrigerator and a magnetical stirrer. The temperature is raised in 30 minutes up to the boiling point of the solvent. The so obtained solution is then kept under reflux and stirring for further 30 minutes. The closed flask is then kept for 30 minutes in a bath of ice and water and in thermostatic water bath at 25° C. for 30 minutes as well. The solid thus obtained is filtered on quick filtering paper and 100 ml of the filtered liquid is poured in a previously weighed aluminum container, which is heated on a heating plate under nitrogen flow, to remove the solvent by evaporation. The container is then kept on an oven at 80° C. under vacuum until constant weight is obtained. The residue is weighed to determine the percentage of xylene-soluble polymer.

### Melt Flow Rate (MFR)

Determined according to ISO 1133 (230° C., 2.16 Kg).

The ISO norm describes the procedure of measuring the MFR values til 150 g/10′. To measure the MFR value of products with higher MFR (up to ca. 3000 g/10′) the unmodified procedure was applied.

### Rheological Measurements/Shear Viscosity:

Determined according ISO 11443. Measurements were performed with a Goettfert Rheograph 2002 Capillary Rheometer at 3 different temperatures (200° C., 230° C. and 250° C.). Capillary length/diameter (L/D) ratio was 40 (length 20 mm, diameter 0.5 mm). Entrance angle 180°

Following abbreviations were used:

gr (l/s): shear rate
tapp (Pa): shear stress
hrc (Pas): viscosity
the viscosity at 100 l/s (250° C.) for products having a nominal MFR between 90 and ca. 500 g/10′ at 230° C. and the viscosity at shear rates of 1500 l/s for products higher than 500 g/10′ at 230° C. have to be considered.

### Flexural Modulus

Determined according to ISO 178

### IZOD Impact Strength

Determined according to ISO 180/1A

### Stress and Elongation at Yield and at Break

Determined according to ISO 527

Melting Temperature, Melting Enthaloy (ΔHm), Crystallization Temperature and Crystallization Enthalpy (ΔHc) determined by DSC according ISO 3146 with a heating rate of 20K per minute

### Haze

Determined according ASTM D 1003

### Gloss

Determined according ASTM 2457 (what means ASTM 523) at 45° and 60°.

### Preparation of Polypropylene Resins

The catalyst system is prepared as described in PCT/EP2004/007061 by using rac-dimethylsilylene(2-methyl-4(4′tertbutyl-penhyl)-indenyl) (2-isopropyl-4(4′tertbutyl-penhyl)-indenyl)zirconium dichloride prepared as described in US 2003/0149199 instead of rac-dimethylsilylbis(2-methyl-4,5-benzo-indenyl)-zirconium dichloride.

### Propylene Polymerization

The catalyst system in the form of catalyst mud obtained as described in PCT/EP2004/007061 is fed in the precontact vessel in which it is diluted with about 5 (Kg/h) of propane. From the pre-contact vessel the catalyst system is fed to the prepolymerization loop in which propylene is fed at the same time according to the data reported in table 1. The residence time of the catalyst in the prepolymerization loop is about 8 minutes. The prepolymerized catalyst obtained in the prepolymerization loop is then continuously feed into the first loop reactor wherein propylene, ethylene and hydrogen were feed according to table 1. The polymer is discharged from the first loop reactor, separated from the unreacted monomer and dried. The reaction conditions are reported in table 1. The MFR of the product is controlled via the feed of hydrogen.

TABLE 1

| | Prepoly- | | | | |
|---|---|---|---|---|---|
| | merization | | | | |
| | temperature | C₃ | C₂ | H₂ | temperature |
| Ex | (° C.) | (Kg/h) | (Kg/h) | (ppm (mol)) | (° C.) |
| 1 | 45 | 336 | 2.2 | 275 | 70 |
| 2 | 45 | 336 | 3.1 | 275 | 70 |
| 3 | 45 | 340 | 4 | 285 | 70 |

MFR and C₂ values were measured on the powder

### Example 1

MFR 150 g/10′, 1.5 wt. % ethylene content (IR)

### Example 2

MFR 110 g/10′, 1.8 wt. % ethylene content (IR)

### Example 3

MFR 132 g/10′, 2.3 wt. % ethylene content (IR)

### Preparation of the Polypropylene Resins According the Invention

For the measurement of the optical and mechanical data, the polymer powder from Example 1 to 3 was additivated and melt mixed with a Berstdorff ZE25 respective Werner& Pfleiderer ZSK53 twin screw extruder according following tables (2 and 3) and pelletized. The temperature on diverese temperature zones represents the measured.values. The setpoints have to be chosen ca 10-20° C. higher and are common knowledge for the extrusion processing to persons skilled in the art.

TABLE 2

| | | Sample | | | |
|---|---|---|---|---|---|
| | | Example 4 | Example 5 | Example 6 | Example 7 |
| Extruder | Unit | ZE25 | ZE25 | ZE25 | ZE25 |
| Irganox B215 | ppm | 1500 | 1500 | 1500 | 1500 |
| Calciumstearate | ppm | 500 | 500 | 500 | 500 |
| Millad 3988 | ppm | 1800 | 1800 | — | 1800 |
| NA 21 | ppm | — | — | 1800 | |
| Polymer powder | % | 99.62 | — | — | — |
| MFR 150 | | | | | |
| (Example 1) | | | | | |
| Polymer powder | % | — | 99.62 | — | — |
| MFR 110 | | | | | |
| (Example 2) | | | | | |
| Polymer Powder | % | — | — | 99.62 | 99.62 |
| MFR 132 | | | | | |
| (Example 3) | | | | | |

The pelletized material was injection moulded (ISO 1873/2). The production of the test specimens required for use related tests and the tests themselves were carried out in accordance with the standards indicated in table 3

TABLE 3

| Method | | | Example 4 | Example 5 | Example 6 | Example 7 |
|---|---|---|---|---|---|---|
| ASTM D 1003 | HAZE (1 MM) | % | 10.3 | 8.2 | 20.4 | 9.2 |
| ASTM 2457/ | GLOSS (placque 1 mm) | % | 131.3 | 134.1 | 116.7 | 133.2 |
| D523 | (60′) | | | | | |
| ASTM 2457/ | GLOSS (placque 1 mm) 45′ | % | 81.5 | 82.8 | 73.9 | 82.7 |
| D523 | | | | | | |
| ISO 180/1A | IZOD 23° C./48 h | KJ/M2 | 3.3 | 4 | 3.5 | 3.6 |
| ISO 180/1A | IZOD 0° C./48 h | KJ/M2 | 1.4 | 1.8 | 2.1 | 2 |
| ISO 178 | Flexual Modulus/48 h | N/MM2 | 1591 | 1448 | 1371 | 1396 |
| ISO 527 | Tensile Modulus/48 h | N/MM2 | 1490 | 1426 | 1343 | 1362 |
| ISO 527 | Stress at Yield/48 h | N/MM2 | 35.5 | 33.6 | 32.4 | 32.6 |
| ISO 527 | Elongation at Yield/48 h | % | 10.3 | 11.2 | 11.6 | 11.6 |
| ISO 527 | Stress at Break/48 h | N/MM2 | 31.2 | 21 | 16.8 | 16.8 |
| ISO 527 | Elongation at Break/48 h | % | 22 | 252 | 365 | 90 |
| ISO 1133 | Melt Flow Rate | g/10 min | 150 | 90.3 | 136 | 137 |
| ISO 3146 | Hc | J/g | −93.7 | −88.1 | −85.3 | −84.5 |
| ISO3146 | Hm | J/g | 97.2 | 91 | 87.8 | 87.4 |
| ISO 3146 | Tm | ° C. | 146.5 | 143.9 | 141.5 | 141.3 |
| ISO 3146 | Tc | ° C. | 112.3 | 109.5 | 106.2 | 107.5 |
| | Ethylene content (IR) | % | 1.6 | 2.6 | 2.1 | 2.9 |
| | Intrinsic viscosity | dl/g | 0.82 | 1 | see. Ex. 7 | 0.86 |
| | Xylene solubles | % | 2 | 1.3 | 1.4 | 1.5 |
| FDA | Hexane extractables, 100 u | % | | | | 0.7 |
| | film | | | | | |
| | Mn (GPC) | g/mol | 47604 | 53411 | see. Ex. 7 | 48760 |
| | Mw (GPC) | g/mol | 121801 | 135142 | see. Ex. 7 | 122931 |
| | Mw/Mn | | 2.6 | 2.5 | see. Ex. 7 | 2.5 |

n.m.: not measured

¹³C-NMR measurements (measured on example 4 and 5) showed for the mmmm pentades 97.2%, 2.1 insertions<=0.2% and 1.3 insertions<0.1%. The ethylene content of Example 4 was 1 wt. %, the ethylene content of example 5 1.5 wt. %.

As the measurement of products with very high Melt flow rate results sometimes in problems with reproducible values, the melt viscosity was determined according ISO 11443 at three different temperatures (200° C.; 230° C. and 250° C.) (table 4 and table 5)

TABLE 4
Example 4

| | | melt | | | melt | | | melt |
|---|---|---|---|---|---|---|---|---|
| | | viscosity | | | viscosity | | | viscosity |
| 200° C. | | | 230° C. | | | 250° C. | | |
| g_{rc} (s⁻¹) | tₐₚₚ (Pa) | h_{rc (}Pa * s) | g_{rc} (s⁻¹) | tₐₚₚ (Pa) | h_{rc (}Pa * s) | g_{rc} (s⁻¹) | tₐₚₚ (Pa) | h_{rc (}Pa * s) |
| 3966.0 | 84422.3 | 21.3 | 8028.8 | 83811.7 | 10.4 | 16124.4 | 103200.0 | 6.4 |
| 1888.9 | 60607.0 | 32.1 | 3797.7 | 60759.6 | 16.0 | 7721.6 | 75720.6 | 9.8 |
| 894.3 | 40913.5 | 45.8 | 1801.3 | 41371.5 | 23.0 | 3676.5 | 52363.2 | 14.2 |
| 426.3 | 26105.3 | 61.2 | 861.1 | 26563.3 | 30.8 | 1766.4 | 34959.7 | 19.8 |
| 205.5 | 15724.2 | 76.5 | 414.6 | 16029.6 | 38.7 | 851.0 | 21983.4 | 25.8 |
| 100.3 | 9007.1 | 89.8 | 203.8 | 9617.7 | 47.2 | 409.6 | 12823.6 | 31.3 |
| 49.2 | 4885.2 | 99.3 | 99.8 | 5343.2 | 53.5 | 202.3 | 7633.1 | 37.7 |
| | | | 49.3 | 2900.6 | 58.9 | 99.7 | 4274.6 | 42.9 |
| | | | | | | 49.2 | 2289.9 | 46.6 |

TABLE 5
Example 7

| | | melt | | | melt | | | melt |
|---|---|---|---|---|---|---|---|---|
| | | viscosity | | | viscosity | | | viscosity |
| 200 | | | 230 | | | 250 | | |
| g_{rc} (s⁻¹) | tₐₚₚ (Pa) | h_{rc (}Pa * s) | g_{rc} (s⁻¹) | tₐₚₚ (Pa) | h_{rc (}Pa * s) | g_{rc} (s⁻¹) | tₐₚₚ (Pa) | h_{rc (}Pa * s) |
| 4065.9 | 89307.5 | 22.0 | 8017.8 | 89612.8 | 11.2 | 34681.3 | 139533.0 | 4.0 |
| 1909.6 | 64576.2 | 33.8 | 3824.2 | 65034.2 | 17.0 | 16579.7 | 107780.0 | 6.5 |
| 903.3 | 44424.8 | 49.2 | 1816.4 | 44577.4 | 24.5 | 7895.5 | 80147.8 | 10.2 |
| 429.9 | 28547.9 | 66.4 | 867.6 | 29005.9 | 33.4 | 3744.2 | 56332.4 | 15.0 |
| 207.8 | 17556.2 | 84.5 | 417.8 | 17861.5 | 42.8 | 1782.1 | 37555.0 | 21.1 |
| 100.9 | 10075.7 | 99.8 | 203.5 | 10533.7 | 51.8 | 854.9 | 23815.3 | 27.9 |
| 49.7 | 5648.5 | 113.7 | 99.9 | 5953.8 | 59.6 | 411.9 | 14197.6 | 34.5 |
| | | | 49.2 | 3205.9 | 65.2 | 203.2 | 8549.1 | 42.1 |
| | | | | | | 100.4 | 4885.2 | 48.7 |
| | | | | | | 49.3 | 2595.3 | 52.7 |

### Comparative Examples 8, 9, 10,11

The polymerization according example 1 was repeated by applying the parameters shown in table 6:

TABLE 6

| | Prepoly- | | | | |
|---|---|---|---|---|---|
| | merization | | | | |
| Comparative | temperature | C₃ | C₂ | H₂ (ppm | temperature |
| Example | (° C.) | (Kg/h) | (Kg/h) | (mol)) | (° C.) |
| 8 | 45 | 336 | 2.2 | 77 | 70 |
| 9 | 45 | 340 | 0 | 320 | 70 |

Following MFR and ethylene content were measured on the powder

### Comparative Example 8

MFR 8 g/10′, 1.6 wt. % ethylene content (IR)

### Comparative Example 9

MFR 149 g/10′ (homopolymer)

For the comparative examples polymer powder according the following tables was additivated (table 7) and extruded.

TABLE 7

| | | Comparative | Comparative |
|---|---|---|---|
| Sample | | Example 10 | Example 11 |
| Extruder | Unit | ZE25 | ZE25 |
| Irganox B215 | ppm | 1500 | 1500 |
| Calciumstearate | ppm | 500 | 500 |
| Millad 3988 | ppm | 1800 | 2000 |
| Polymer powder MFR 8 | % | 99.62 | — |
| (Comparative Example 8) | | | |
| Polymer powder MFR 150 | % | — | 99.62 |
| (Comparative Example 9) | | | |

The pelletized material was injection moulded (ISO 1873/2). The production of the test specimens required for use related tests and the tests themselves were carried out in accordance with the standards indicated in table 8:

TABLE 8

| | | | Comparative | Comparative |
|---|---|---|---|---|
| | | | Example 10 | Example 11 |
| ASTM D 1003 | HAZE (1 MM) | % | 9.6 | 13.3 |
| ASTM 2457/ | GLOSS (placque 1 mm) (60′) | % | 137.5 | 124.4 |
| D523 | | | | |
| ASTM 2457/ | GLOSS (placque 1 mm) 45′ | % | 84 | 77.9 |
| D523 | | | | |
| ISO 180/1A | IZOD 23° C./48 h | KJ/M2 | 4.3 | 2.5 |
| ISO 180/1A | IZOD 0° C./48 h | KJ/M2 | 2.3 | 1.2 |
| ISO 178 | Flexual Modulus/48 h | N/MM2 | 1482 | 1939 |
| ISO 527 | Tensile Modulus/48 h | N/MM2 | 1364 | 1857 |
| ISO 527 | Stress at Yield/48 h | N/MM2 | 34.5 | 40.3 |
| ISO 527 | Elongation at Yield/48 h | % | 9.9 | 7.9 |
| ISO 527 | Stress at Break/48 h | N/MM2 | 26.3 | 38.5 |
| ISO 527 | Elongation at Break/48 h | % | 734 | 14 |
| ISO 1133 | Melt Flow Rate | g/10 min | 7.5 | 146 |
| ISO 3146 | Hc | J/g | −90.9 | −108.6 |
| ISO 3146 | Hm | J/g | 92.1 | 108.4 |
| ISO 3146 | Tm | ° C. | 146.1 | 158.1 |
| ISO 3146 | Tc | ° C. | 110.1 | 117.7 |
| | Ethylene content (IR) | % | 2 | 0 (homo- |
| | | | | polymer) |
| | Xylene solubles | % | 1 | 0.5 |
| | Mn (GPC) | g/mol | n.m. | 52425 |
| | Mw(GPC) | g/mol | n.m. | 120263 |
| | Mw/Mn | | n.m. | 2.3 |
| | Intrinsic viscosity | | n.m. | 0.86 |
| FDA | Hexane extractables, 100 u film | % | n.m. | n.m. |

The isotactic pentades (mmmm) of the polymer of comparative examples 10 and 11 are higher than 95%. The 2.1 insertions are <0.3% and the 1.3 insertions<0.1

As can be seen the comparative Example 10 is a Random copolymer with the same melting point as Example 4 but lower MFR. The stiffness of comparative example 10 is lower than the stiffness of Example 4. Comparative Example 11 represents a homopolymer at a high MFR of 146 g/10′ at 230° C.

Random Copolymers with High MFR.

The production of random copolymers with Melt flow rates higher than 500 g/10′ was done according to examples 1-3, but by using the polymerization conditions reported on table 9.

TABLE 9

| | Prepoly- | | | | |
|---|---|---|---|---|---|
| | merization | First reactor | | | |
| | temperature | C₃ | C₂ | H₂ | temperature |
| Ex | (° C.) | (Kg/h) | (Kg/h) | (ppm (mol)) | (° C.) |
| 12 | 45 | 333 | 4 | 763 | 70 |
| 13 | 45 | 340 | 2 | 728 | 70 |
| 14 | 45 | 340 | 2 | 760 | 70 |

Following MFR values and ethylene contents were measured on the powder

### Example 12

MFR 1225 g/10′, 2.3 wt. % ethylene content (IR)

### Example 13

MFR 1307 g/10′, 1.6 wt. % ethylene content (IR)

### Example 14

MFR 1670 g/10′ 1.3 wt. % ethylene content (IR)

The powder of Example 12, Example 13 and Example 14 was characterized in powder form (table 12):

TABLE 10

| Method | Variable Name | Units | Example 12 | Example 13 | Example 14 |
|---|---|---|---|---|---|
| ISO1133 | Melt Flow Rate | g/10 min | 1100 | 1300 | 1670 |
| ISO3146 | Hc | J/g | −86.3 | −94.8 | −84.5 |
| ISO3146 | Hm | J/g | 90.1 | 99.7 | 82.1 |
| ISO3146 | Tm | deg_C. | 139.5 | 146.7 | 145.1 |
| ISO3146 | Tc | deg_C. | 92.3 | 97.9 | 101.3 |
| | Intrinsic viscosity | dl/g | 0.57 | 0.55 | 0.49 |
| | Xylene solubles | % | 2.1 | 1.5 | 1.5 |
| | Ethylene content (IR) | wt. % | 2.4 | 1.4 | 1.2 |
| | Mn (GPC) | g/mol | 25134 | 28157 | 25642 |
| | Mw(GPC) | g/mol | 68279 | 70163 | 65037 |
| | Mw/Mn | | 2.7 | 2.5 | 2.5 |
| FDA | Hexane Extractables 100 u film | % | 1.6 | 1.6 | 1 |

The isotactic pentades (mmmm) of the polymer of examples 12-14 are higher than 95%. The 2.1 insertions are ≦0.3% and the 1.3 insertions≦0.1

The melt viscosity was determined according ISO 11443 at three different temperatures (200° C.; 230° C. and 250° C.) (table 11 and table 12 for example 12 and example 13).

TABLE 11
Example 12

| | | melt | | | melt | | | melt |
|---|---|---|---|---|---|---|---|---|
| | | viscosity | | | viscosity | | | viscosity |
| 200° C. | | | 230° C. | | | 250° C. | | |
| g_{rc} (s⁻¹) | tₐₚₚ (Pa) | h_{rc (}Pa * s) | g_{rc} (s⁻¹) | tₐₚₚ (Pa) | h_{rc (}Pa * s) | g_{rc} (s⁻¹) | tₐₚₚ (Pa) | h_{rc (}Pa * s) |
| 66691.9 | 127473.0 | 1.9 | 67604.9 | 98314.6 | 1.5 | 65549.8 | 86101.6 | 1.3 |
| 31439.2 | 94192.7 | 3.0 | 29993.1 | 69919.4 | 2.3 | 28956.9 | 58622.4 | 2.0 |
| 14722.6 | 65797.5 | 4.5 | 13825.8 | 46104.1 | 3.3 | 13412.4 | 37402.3 | 2.8 |
| 6948.4 | 43356.1 | 6.2 | 6596.9 | 28547.9 | 4.3 | 6456.1 | 22441.4 | 3.5 |
| 3322.6 | 26715.9 | 8.0 | 3216.7 | 16640.2 | 5.2 | 3164.1 | 12518.3 | 4.0 |
| 1610.0 | 15418.9 | 9.6 | 1585.0 | 9159.8 | 5.8 | 1570.4 | 6717.2 | 4.3 |
| 791.4 | 8549.1 | 10.8 | 780.7 | 4732.5 | 6.1 | 783.9 | 3511.2 | 4.5 |
| 388.7 | 4427.2 | 11.4 | 384.7 | 2289.9 | 6.0 | 384.9 | 1679.3 | 4.4 |
| | | | | | | 195.9 | 763.3 | 3.9 |

TABLE 12
Example 13

| | | melt | | | melt | | | melt |
|---|---|---|---|---|---|---|---|---|
| | | viscosity | | | viscosity | | | viscosity |
| 200° C. | | | 230° C. | | | 250° C. | | |
| g_{rc} (s⁻¹) | tₐₚₚ (Pa) | h_{rc (}Pa * s) | g_{rc} (s⁻¹) | tₐₚₚ (Pa) | h_{rc (}Pa * s) | g_{rc} (s⁻¹) | tₐₚₚ (Pa) | h_{rc (}Pa * s) |
| 73848.6 | 124878.0 | 1.7 | 67351.6 | 98314.6 | 1.5 | 57569.8 | 84727.6 | 1.5 |
| 31963.4 | 92360.8 | 2.9 | 29985.0 | 69919.4 | 2.3 | 27721.6 | 57706.4 | 2.1 |
| 14494.8 | 64576.2 | 4.5 | 13833.2 | 46104.1 | 3.3 | 13463.8 | 36944.3 | 2.7 |
| 6810.7 | 42134.8 | 6.2 | 6599.5 | 28547.9 | 4.3 | 6583.6 | 22136.1 | 3.4 |
| 3285.2 | 25800.0 | 7.9 | 3217.0 | 16640.2 | 5.2 | 3226.1 | 12365.7 | 3.8 |
| 1607.2 | 14808.3 | 9.2 | 1584.8 | 9159.8 | 5.8 | 1595.6 | 6717.2 | 4.2 |
| 793.1 | 8091.1 | 10.2 | 780.5 | 4732.5 | 6.1 | 780.8 | 3358.6 | 4.4 |
| 389.7 | 4121.9 | 10.6 | 384.8 | 2289.9 | 6.0 | 385.3 | 1679.3 | 4.4 |
| 192.9 | 1984.6 | 10.3 | 192.7 | 1221.3 | 6.3 | 196.6 | 763.3 | 3.9 |

1. A polypropylene resin comprising: a propylene copolymer
comprising a melt flow rate (MFR) (ISO 1133) (230° C./2.16 kg) between 90 and 3000 g/10′ and a melting point measured by DSC between 135° C. and 152° C., both the melt flow rate and melting point being measured on the powder, wherein the propylene copolymer is not visbroken;
a distribution of molecular weight Mw/Mn lower than 4;
hexane extractables according to FDA regulations of less than 2.6 wt. %;
xylene solubles of less than 2.2 wt. %; and
isotactic pentads (mmmm) measured with by ¹³C-NMR higher than 90%.

2. The polypropylene resin according to claim 1, further comprising:
a haze measured according to ASTM D 1003 (1 mm placque) between 5% and 30%; and
a flexural modulus measured according to ISO 178 after 48 h between 1100 N/m² and 2000 N/m².

3. The polypropylene resin according to claim 1 wherein the copolymer is a propylene copolymer containing up to 5% by mol of ethylene or alpha olefins of formula CH₂═CHA derived units, wherein A is a C₂-C₂₀ alkyl radical.

4. The polypropylene resin according to claim 1, wherein for an MFR value between 90 and 500 g/10′ at 230° C., at a shear rate of 100 1/s at 250° C., the polypropylene resin further comprises a melt viscosity between 100 Pas and 11 Pas.

5. The polypropylene resin according to claim 1, wherein for an MFR value higher than 500 g/10′ at 230° C., at a shear rate of 1500 1/s at 250° C., the polypropylene resin further comprises a viscosity between 11 Pas and 1 Pas.

6. The polypropylene resin according to claim 1, further comprising from 0.1 to 1% by weight of a nucleating agent.

7. The polypropylene resin according to claim 1, wherein the melt flow rate (MFR) (ISO 1133) (230° C./2.16 kg) is between 120 and 3000 g/10′.

8. The propylene resin according to claim 2, wherein the haze is between 5% and 25%.

9. The propylene resin according to claim 2, wherein the flexural modulus is between 1200 N/m² and 2000 N/m².

10. A process comprising producing a molded article comprising a polypropylene resin, the polypropylene resin comprising:
a propylene copolymer comprising a melt flow rate (MFR) (ISO 1133) (230° C./2.16 kg) between 90 and 3000 g/10′ and a melting point measured by DSC between 135° C. and 152° C., both the melt flow rate and melting point being measured on the powder, wherein the propylene copolymer is not visbroken;
a distribution of molecular weight Mw/Mn lower than 4;
hexane extractables according FDA regulations of less than 2.6 wt. %;
xylene solubles of less than 2.2 wt. %; and
isotactic pentads (mmmm) measured with by ¹³C-NMR higher than 90%.

11. A molded article comprising a polypropylene resin, the polypropylene resin comprising:
a propylene copolymer comprising a melt flow rate (MFR) (ISO 1133) (230° C./2.16 kg) between 90 and 3000 g/10′ and a melting point measured by DSC between 135° C. and 152° C., both measured on the powder, wherein the propylene copolymer is not visbroken;
a distribution of molecular weight Mw/Mn lower than 4;
hexane extractables according FDA regulations of less than 2.6 wt. %;
xylene solubles of less than 2.2 wt. %; and
isotactic pentads (mmmm) measured with by ¹³C-NMR higher than 90%.
